(19) United States
(12) Patent Application Publication
(10) Pub. No.: US 2024/0103313 A1
(43) Pub. Date: Mar. 28, 2024

(54) SELECTIVE COMMUNICATION USING MULTIPLE SEPARATED POLARIZERS

(71) Applicant: Evital LLC, Denver, CO (US)

(72) Inventor: Nicholas Patrick Hunter, Denver, CO (US)

(21) Appl. No.: 18/472,951

(22) Filed: Sep. 22, 2023

Related U.S. Application Data
(60) Provisional application No. 63/409,248, filed on Sep. 23, 2022.

(51) Int. Cl. G02F 1/1335; G02B 27/28

(52) U.S. Cl. CPC G02F 1/133528; G02B 27/283; G02B 27/286

(57) ABSTRACT

A polarizer is an optical filter that lets light waves of a specific polarization pass through while blocking light waves of other polarizations. It can filter a beam of light of undefined or mixed polarization into a beam of well-defined polarization, that is polarized light. The presently disclosed technology is generally directed to using two or more separated layers of polarized film or other polarized structures to selectively block incoming light to a user's eyes or electromagnetic radiation (EMR) to a sensor, which serves to selectively communicate information to the user or sensor. In some implementations, one or more of the layers of polarized film is moveable or rotatable to actively adjust the EMR blockage.

### CROSS-REFERENCE TO RELATED APPLICATIONS

The present application claims benefit of priority to U.S. Provisional Patent Application No. 63/409,248 entitled “Selective Communication Using Multiple Separated Polarized Screens” and filed on Sep. 23, 2022, which is specifically incorporated by reference herein for all that it discloses or teaches.

### BACKGROUND

A polarizer is an optical filter that lets light waves of a specific polarization pass through while blocking light waves of other polarizations. It can filter a beam of light of undefined or mixed polarization into a beam of well-defined polarization, that is polarized light. Common types of polarizers include linear polarizers and circular polarizers. Polarizers are used in many optical techniques and instruments, and polarizing filters find applications in photography and liquid-crystal display (LCD) technology, for example. Polarizers can also be used for filtering types of electromagnetic waves beyond visible light, such as radio waves, microwaves, and X-rays.

### SUMMARY

Implementations described and claimed herein address the foregoing problems by providing an electromagnetic communication system comprising: an electromagnetic source existing in a first environment; a first polarized medium having a first polarization direction separating the first environment from a second environment; and a second polarized medium having a second polarization direction separating the second environment from a third environment, the first polarization direction differing from the second polarization direction, wherein electromagnetic waves originating from the first environment are substantially blocked from passing directly through the second environment to the third environment.

Other implementations are also described and recited herein.

### BRIEF DESCRIPTION OF THE DRAWINGS

FIG. 1 illustrates an example set of environments separated by adjustable optical filters between a light source and a user.

FIG. 2 illustrates an example use case where a light source communicates two set of information, only one of which reaches the users depending on their use of optical filters A and B.

FIG. 3 illustrates an example use case where a camera receives light indirectly from a light source illuminating a target, but not directly from the light source.

FIG. 4 illustrates an example use case where two disparately located cameras receive light indirectly from a light source illuminating a target, but not directly from the light source.

FIG. 5 illustrates an example use case where a user's eye receives light indirectly from a light source illuminating a target, but not directly from the light source.

FIG. 6 illustrates an example use case where two users are concealed from one another, but a third user is visible to both the first two users.

FIG. 7 illustrates an example use case where a first car's headlights are substantially concealed from a driver in a second oncoming car to reduce glare and the associated distraction and reduced vision of surrounding objects.

FIG. 8 illustrates example operations for communicating information through at least two polarized filters.

FIG. 9 illustrates a point source of light that illuminates an object of interest, and how that object of interest if viewed through Camera A and Camera B.

FIG. 10 illustrates a radial arrangement of polarizers with corresponding electromagnetic wave sources focused on sensors on an object or within an area of interest.

FIG. 11 illustrates a system of a set of three polarizers that operate in combination to separate constituent frequencies of an incoming beam of light from a source, polarize that light so as to distinguish that light from other light incoming from other sources, and filter those frequencies to pass only those of interest that are specific to the source.

FIG. 12 illustrates a driver's perspective through a windshield equipped with a polarized shade band.

### DETAILED DESCRIPTION

The presently disclosed technology is generally directed to using two or more separated layers of polarized film applied to glass or a lens, for example, or other polarized structure to selectively block incoming light to a user's eyes or electromagnetic radiation (EMR) to a sensor, which serves to selectively communicate information to the user or sensor. In some implementations, the polarized optical filter may take the form of a natural crystal (e.g., calcite and quartz) or man-made equivalent that divides a single beam of unpolarized light into two separate polarized beams. By splitting the two polarized beams, it is possible to make a very efficient linear polarizer using the natural or man-made crystal. In some implementations, one or more of the layers of polarized film is moveable or rotatable to actively adjust the EMR blockage. In addition, the layers of polarized film may be actively adjustable by selectively turning the polarization of one or both layers on and off.

As illustrated herein, solid lines generally depict opaque structures that block substantially all light from passing therethrough, while broken lines depict at least partially transparent structures having a polarized optical filter applied thereto. Differing broken lines depict polarized optical filters having different polarization directions within a singular illustration. Arrows generally depict transmission of light or other electromagnetic waves.

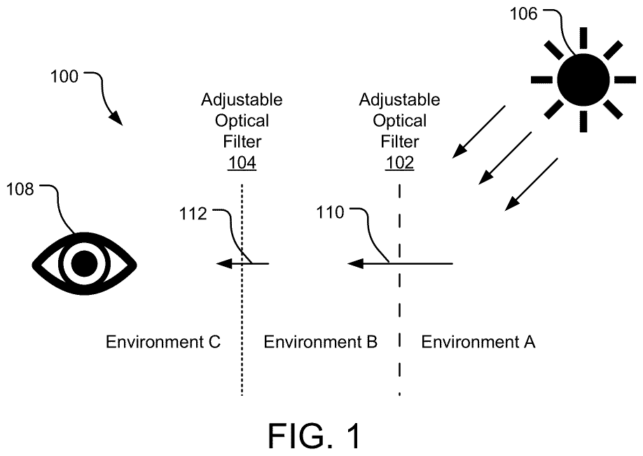

FIG. 1 illustrates an example set of environments (Environment A, Environment B, and Environment C) 100 separated by adjustable optical filters 102, 104 between a light source 106 and a user's eye(s) 108. While illustrated as the sun, the light source 106 may be any point or distributed source of light (e.g., ambient lighting, a light bulb, a laser, etc.) that originates within or passes through Environment A on its way to Environment B. In an example implementation, Environment A is an exterior environment where a variety of sources are present, some or all of which originate with light emitted from the sun. Further, in FIG. 1, Environment C is assumed to be positioned such that any light originating from Environment A must pass through Environment B to reach Environment C.

Environment B is representative of an environment shielded from Environment A using the adjustable optical filter 102, which is a polarized optical filter taking the form of a film applied to glass or a lens, for example. The optical filter 102 permits some light from the Environment A to pass therethrough, specifically light waves of a specific polarization corresponding to the optical filter 102, as illustrated by arrow 110. Other light is blocked from passing through the optical filter 102. In an example implementation, Environment B is an interior environment where light coming from Environment A through a window having the optical filter 102 is filtered.

Environment C is representative of an environment further shielded from Environment A using the adjustable optical filter 104, which is another polarized optical filter taking the form of a film applied to glass or a lens, for example. The optical filter 104 permits additional light from the Environment B to pass therethrough, specifically light waves of a specific polarization corresponding to the optical filter 104, as illustrated by arrow 112. Arrow 112 is smaller than arrow 110, which illustrates that generally less light reaches Environment C than Environment B. In an example implementation, Environment C is an interior environment around the user's eye(s) 108, where light coming from Environment A is further filtered by the optical filter 104, which may be a pair of glasses that the user is wearing over their eye(s) 108.

In sum, the presently disclosed technology uses multiple optical filter partitions, each of which separate two environments (e.g., Environments A-C). In some implementations, one or both of the optical filters 102, 104 are rotatable to selectively vary the amount of light transmission through both of the optical filters 102, 104. For example, when the polarization direction of both filters 102, 104 is substantially aligned, the combination of both optical filters 102, 104 blocks little to no additional light than one of the filters 102, 104 alone. In contrast, when one of the optical filters 102, 104 is oriented with a polarization direction substantially 90-degrees from that of the other of the optical filters 102, 104, a maximum quantity of light is blocked by the combination of both of the optical filters 102, 104, which is much greater than that of one of the optical filters 102, 104.

In an example implementation, overall light blocking may be from 20% (or less) when the polarization direction of both filters 102, 104 is substantially aligned. Similarly, overall light blocking may be 80% (or more) when a polarization direction of one of the filters 102, 104 is substantially 90-degrees from that of the other of the optical filters 102, 104. In another example implementation, overall light blocking is less than 1% when the polarization direction of both filters 102, 104 is substantially aligned. Overall light blocking is 70-80% when a polarization direction of one of the filters 102, 104 is substantially 90-degrees from that of the other of the optical filters 102, 104 Further, orientations between 0-degrees and 90-degrees may be used to achieve light blockage between maximums and the minimums provided by the pairing of the filters 102, 104.

In an example implementation, a film of polarized translucent material is placed over a jobsite light that serves as the optical filter 102 and a worker wears eyewear with polarized lenses that serve as the optical filter 104. An orientation of the polarized translucent material over the jobsite light is rotated to be at an acute angle in relation to the polarized translucent eyewear creating a significant filter of light emitted directly from the jobsite light, but less so of diffuse light within the worker's workspace. This allows adequate illumination of the workspace, while keeping the worker from being blinded by the jobsite light itself.

In some implementations, there may be a number of different types of polarizing converters (e.g., a circular to linear converter, and vice versa) to shape, change, and specify communication routes through all types of electromagnetic waves pass through the filters 102, 104.

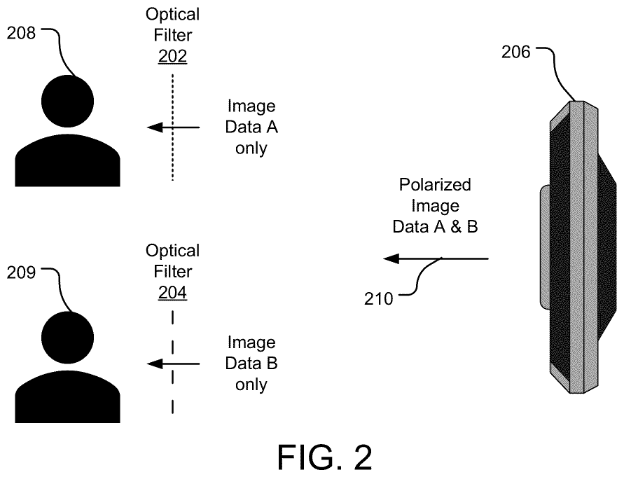

FIG. 2 illustrates an example use case where a light source 206 communicates two set of visual information (e.g., Polarized Image Data A and Polarized Image Data B), only one of which reaches each of users 208, 209 depending on their selective use of optical filters 202, 204. The light source 206 is illustrated in FIG. 2 as a television set, however, any light source that is capable of overlaying two sets of information transmissible by light, the two sets of information polarized 90-degrees from one another, would function similarly. The light source 206 emits the polarized visual information, described herein as Polarized Image Data A and Polarized Image Data B toward the users 208, 209, as illustrated by arrow 210.

In various implementations, the optical filters 202, 204 are designed to operate on a per-pixel basis (i.e., the optical filters 202, 204 are not homogeneous across their respective areas, such as a checkerboard or shutter pattern). This adds additional flexibility is determining which information to transmit vs. which information to block. In an example use case, a billboard or sign may include two different sets of information (e.g., languages or advertisements) and the optical filters 202, 204 determine which set of information is visible to a user.

The users 208, 209 are each wearing polarized glasses or otherwise oriented behind optical filters 202, 204, respectively. In other implementations, the optical filters 202, 204 could be contact lenses or a film applied to a window from which the users 208, 209 are viewing the light source 206. The optical filter 202 is oriented to permit the Polarized Image Data A to pass therethrough while blocking the Polarized Image Data B. Thus, the user 208 only views the Polarized Image Data A output from the light source 206. Similarly, the optical filter 204 is oriented to permit the Polarized Image Data B to pass therethrough while blocking the Polarized Image Data A. Thus, the user 209 only views the Polarized Image Data B output from the light source 206

The use case of FIG. 2 has various applications. For example, the light source 206 may output two overlaid television shows and the users 208, 209 may elect which to watch based on their selection of eyewear. Further, the light source 206 may output Polarized Image Data A that is intended for or relevant to only user 208 and Polarized Image Data B that is intended for or relevant to only user 209. Singular light source 206 may be used to output both sets of data. Further, a third user without either of the optical filters 202, 204 may find it difficult to understand the data output from the light source 206 as it would appear as both sets of polarized Image Data A & B overlaid on top of one another, which may render the data unintelligible. In this manner, the polarized Image Data A & B may be privately communicated to the users 208, 209, respectively, without inadvertently transmitting either of the polarized Image Data A & B to the third user.

In some implementations, the use case of FIG. 2 could be used as a form of encryption of data if either of the communicated polarized Image Data A & B is not useful alone and only both of the polarized Image Data A & B is necessary to retrieve useful data. While a television is explicitly shown as light source 206, any source of light that conveys multiple sets of information is contemplated herein.

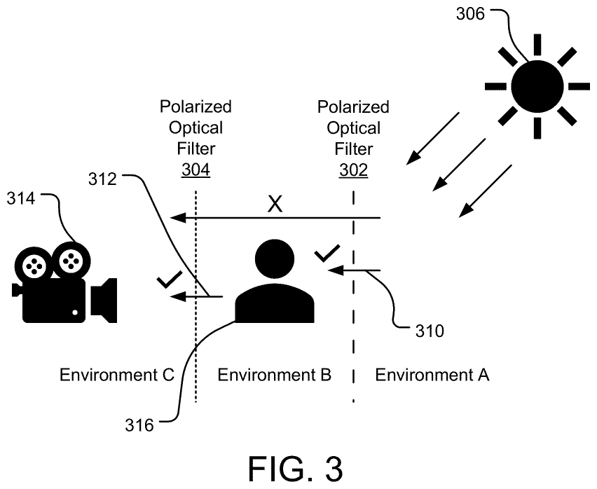

FIG. 3 illustrates an example use case where a camera 314 receives light indirectly from a light source 306 illuminating a target 316, but not directly from the light source 306. While illustrated as the sun, the light source 306 may be any point or distributed source of light (e.g., ambient lighting, a light bulb, a laser, etc.) that originates within or passes through Environment A on its way to Environment B. In an example implementation, Environment A is an exterior environment where a variety of light sources are present, some or all of which originate with light emitted from the sun. Further, in the use case of FIG. 3, Environment C is assumed to be positioned such that any light originating from Environment A must pass through Environment B to reach Environment C.

Environment B is representative of an environment shielded from Environment A using polarized optical filter 302, which is a polarized optical filter taking the form of a film applied to glass or a lens, for example. The optical filter 302 permits some light from the Environment A to pass therethrough, specifically light waves of a specific polarization corresponding to the optical filter 302, as illustrated by arrow 310. The light illustrated by arrow 310 enters Environment B and illuminates the target 316 (e.g., one or more persons or objects), as well as the surrounding structure of the Environment B. Other light from Environment A is blocked from passing through the optical filter 302. In an example implementation, Environment B is an interior environment where light coming from Environment A through a window having the optical filter 302 is filtered.

Environment C is representative of an environment further shielded from Environment A using polarized optical filter 304, which is another polarized optical filter taking the form of a film applied to glass or a lens, for example. The optical filter 304 permits a majority of diffuse (e.g., reflected and/or refracted light) within the Environment B to pass therethrough, as illustrated by arrow 312. However, a majority of light waves are prevented from passing directly from Environment A to Environment C by way of Environment B using the polarization of the optical filter 304.

In an example implementation, Environment C is an interior environment behind a camera lens that functions as optical filter 304. The camera 314 is shielded by the optical filters 302, 304 from light directly coming from the light source 306, but the light source 306 adequately illuminates the target 316 which is being filmed by the camera 314.

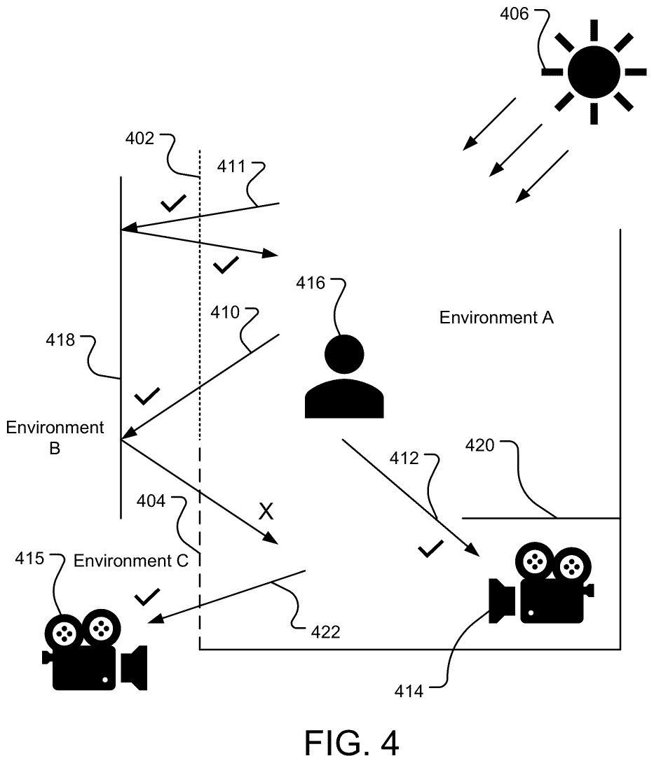

FIG. 4 illustrates an example use case where two disparately located cameras 414, 415 receive light indirectly from a light source 406 illuminating a target 416, but not directly from the light source 406. While illustrated as the sun, the light source 406 may be any point or distributed source of light (e.g., ambient lighting, a light bulb, a laser, etc.) that originates within or passes through Environment A on its way to Environment B. In an example implementation, Environment A is semi-enclosed environment having a substantial opening where a variety of light sources are present, some or all of which originate with light emitted from the sun. The light entering Environment A illuminates the target 416 (e.g., one or more persons or objects), as well as the surrounding structure of the Environment A.

Environment B is representative of an environment shielded from Environment A using polarized optical filter 402, which is a polarized optical filter taking the form of a film applied to glass or a lens, for example. The optical filter 402 permits some light from the Environment A to pass therethrough, specifically light waves of a specific polarization corresponding to the optical filter 402, as illustrated by arrow 410. Environment B is equipped with a mirror 418 that reflects the light received into Environment B from Environment A back toward Environment A. However, the reflected light is directed through optical filter 404, which is another polarized optical filter taking the form of a film applied to another area of the glass or a lens, for example. The reflected light is directed through optical filter 404 is substantially blocked from passing through the optical filter 404 and re-entering Environment A. In other implementations, the reflected light is substantially permitted to re-enter Environment A so long as it is reflected back through the same optical filter from which it originated from Environment A, as illustrated by arrow 411, rather than through a different optical filter, as illustrated by arrow 410.

Camera 414 is positioned within Environment A behind shield 420, which blocks light from the light source 406 from directly reaching the camera 414. The camera 414 is able to film the target 416, as illustrated by arrow 412. The target 416 is illuminated by light from the light source 406. The camera 414 is further shielded from light reflected within Environment B, so long as the light passes through both optical filters 402, 404. If the light reflected within Environment B only passes through one of the optical filters 402, 404, it is substantially reflected to the camera 414. This effect may aid in positioning and alignment of the light source 406 and the camera 414 within the Environment A. Camera 415 is positioned within Environment C, which is also behind optical filter 404. Light originating within Environment A is generally permitted to pass through the optical filter 404 to reach the camera 415, as illustrated by arrow 422.

In some implementations, multiple cameras may be incorporated one or more of cameras 414, 415, some of which some do horizontal polarization scanning and others of which do vertical scanning, which can result in a quickly scanned 3D object, such as in MRI imaging of an area of tissue. In other implementations, the optical filters 402, 404 can be selectively used to block areas of light for a 3D printing application where the object is cured layer-by-layer by light rays. In still further implementations, the optical filters 402, 404 can be selectively used to block areas of light to protect surrounding tissue during laser ablation of tumors. The implementation of FIG. 4 may also use multiple light sources, such as light source 406. The implementation of FIG. 4 could further be adapted to a polar targeting array, selectively permitting, and blocking information from passing radially inward or outward to and from a center. The implementation of FIG. 4 could further still be applied to a 3D imaging array.

Some implementations may adopt circular polarizers for the optical filters 402, 404. In such implementations, the optical filters 402, 404 may be flipped rather than rotated (as described above) to affect the transmissibility of light through the optical filters 402, 404. In general, a specific side towards the mirror 418 of each of the optical filters 402, 404 blackens and the other side lets the light though.

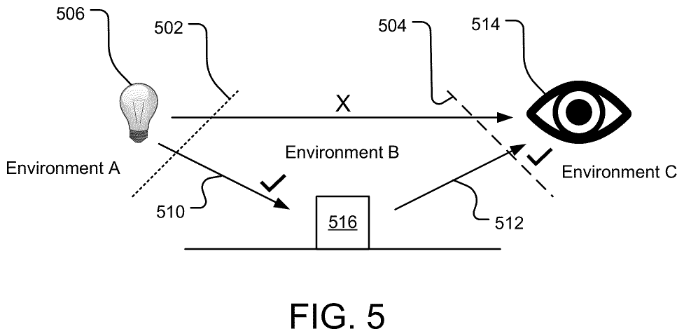

FIG. 5 illustrates an example use case where a user's eye 514 receives light indirectly from a light source 506 illuminating a target 516, but not directly from the light source 506. While illustrated as a light bulb, the light source 506 may be any point or distributed source of light that originates within or passes through Environment A on its way to Environment B. In an example implementation, Environment A is a point source of light, such as a work light. Further, in the use case of FIG. 5, Environment C is assumed to be positioned such that any light originating from Environment A must pass through Environment B to reach Environment C.

Environment B is representative of an environment shielded from Environment A using polarized optical filter 502, which is a polarized optical filter taking the form of a film applied to glass or a lens placed over the work light, for example. The optical filter 502 permits some light from the Environment A to pass therethrough, specifically light waves of a specific polarization corresponding to the optical filter 502, as illustrated by arrow 510. The light illustrated by arrow 510 enters Environment B and illuminates the target 516 (e.g., a work piece), as well as the surrounding structure of the Environment B. Other light from Environment A is blocked from passing through the optical filter 502. In an example implementation, Environment B is an environment where light coming from Environment A through a lens having the optical filter 302 placed over the work light is filtered.

Environment C is representative of an environment further shielded from Environment A using polarized optical filter 504, which is another polarized optical filter taking the form of a film applied to glass or a lens that a user wears as eyewear, for example. The optical filter 504 permits a majority of diffuse (e.g., reflected and/or refracted light) within the Environment B to pass therethrough, as illustrated by arrow 512. However, a majority of light waves are prevented from passing directly from Environment A to Environment C by way of Environment B using the polarization of the optical filter 504.

In an example implementation, the user's eye 514 is shielded by the optical filters 502, 504 from light directly coming from the light source 506, but the light source 506 adequately illuminates the target 516 which is being viewed by the user's eye 514. This can reduce glare and districting point source light from the user's field of vision.

In another implementation, the optical filter 502 may be placed over an oncoming automobile headlight and the optical filter 504 may be incorporated into the user's windshield and/or eyewear. The user's eye 514 is shielded by the optical filters 502, 504 from light directly coming from the oncoming automobile headlight, but the oncoming automobile headlight adequately illuminates a field of view between the oncoming automobile headlight and the user's eye 514.

In yet another implementation, the optical filter 502 may be placed over a workpiece to be welded and the optical filter 504 may be incorporated into the user's welding mask. The user's eye 514 is shielded by the optical filters 502, 504 from light directly coming from welding operations on the workpiece, but the workpiece and surrounding environment is adequately illuminated to the user's eye 514 without a particularly dark non-polarized filter applied to the user's welding mask. This allows the user to view their environment around the workpiece without removing their welding mask. Further, the workpiece may be visible if the user's eye 514 as well with a digitally darkening welding mask lens that darkens (or selectively applies polarization) on application of bright light. Still further, polarized curtains may be used to shield and area where welding operations are taking place so that bystanders are protected from the bright light.

In various implementations herein, blocked or substantially blocked indicates a greater than 20% reduction in light intensity while passing or substantially passing light indicates a less than 10% reduction in light intensity. In other implementations, blocked or substantially blocked indicates two or more optical filters with a polarization direction arranged substantially 90-degrees (e.g., in excess of 80-degrees) from one another. In still other implementations, blocked or substantially blocked indicates blocking of light exceeding a doubling of the polarization filters arranged in parallel. This is in contrast to two parallel filters arranged in an acute angle compared to generally parallel.

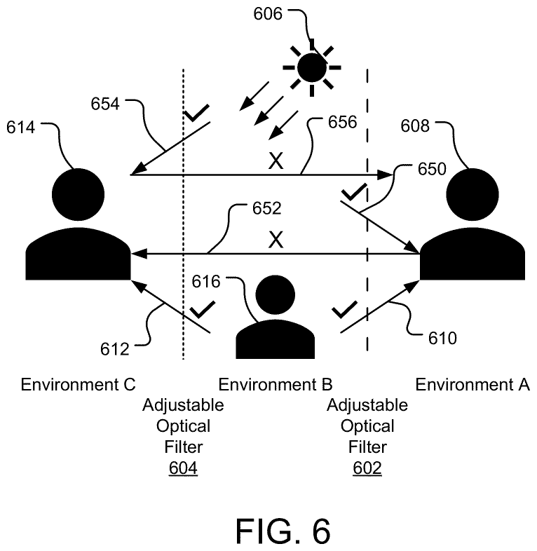

FIG. 6 illustrates an example use case where users 608, 614 are concealed from one another, but user 616 is visible to both the users 608, 614. While illustrated as the sun, light source 606 may be any point or distributed source of light (e.g., ambient lighting, a light bulb, a laser, etc.) that originates within or passes through Environment B on its way to Environments A and C. In an example implementation, Environments A and C are enclosed environments (e.g., inside vehicles or buildings, such as houses), each having a substantial opening (e.g., windows or other openings) into Environment B (e.g., outside) where a variety of light sources are present, some or all of which originate with light emitted from the sun. The light source 606 illuminates the user 616 (and other persons and objects within Environment B).

In an example use case, users 608, 614 are each located in adjacent houses and polarized optical filters 602, 604 are applied to windows in each of the user's 608, 614 homes, respectively. Each of the users 608, 614 are permitted to see the user 616 outside, but neither the users 608, 614 are permitted to see inside the other's house.

Environment B is representative of an outside environment where numerous objects, including the user 616, are illuminated by the light source 606. The user 616 is visible to each of the users 608, 614 as some light from the Environment B to passes through optical filters 602, 604 to users 608, 614, respectively, specifically light waves of a specific polarization corresponding to the optical filters 602, 604, as illustrated by arrows 610, 612, respectively.

Environment A is representative of an environment shielded from Environment C using a combination of the polarized optical filters 602, 604, each of which may take the form of a film applied to glass or a lens placed over the users 608, 614 windows, for example. Specifically, the optical filter 602 permits some light from the Environment B to pass therethrough, specifically light waves of a specific polarization corresponding to the optical filter 602, as illustrated by arrow 650. The light illustrated by arrow 650 enters Environment A and illuminates the user 608, as well as the surrounding structure of the Environment A. However, light reflected or refracted from the user 608 and the surrounding structure of Environment A back through the optical filter 602 to Environment B is substantially prevented from entering Environment C due to the optical filter 604, as illustrated by arrow 652.

Similarly, Environment C is representative of an environment shielded from Environment A using a combination of the polarized optical filters 602, 604. Specifically, the optical filter 604 permits some light from the Environment B to pass therethrough, specifically light waves of a specific polarization corresponding to the optical filter 604, as illustrated by arrow 654. The light illustrated by arrow 654 enters Environment C and illuminates the user 614, as well as the surrounding structure of the Environment C. However, light reflected or refracted from the user 614 and the surrounding structure of Environment C back through the optical filter 604 to Environment B is substantially prevented from entering Environment A due to the optical filter 602, as illustrated by arrow 656.

The implementation of FIG. 6 may further be used to shield caged or fenced animals from view of one another, while still permitting the animals to be illuminated and viewable from an exterior of the cage or fence. The implementation of FIG. 6 may further still be used as privacy screens for vehicle side windows.

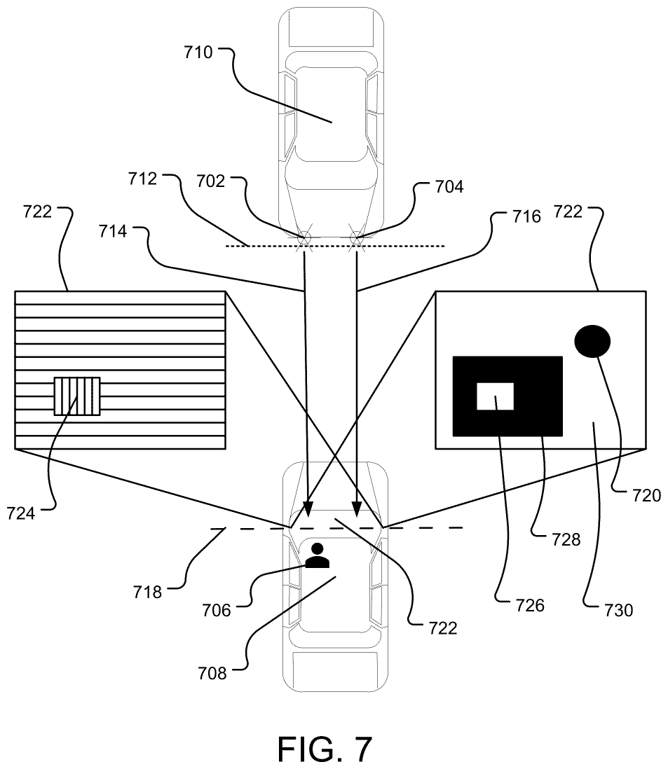

FIG. 7 illustrates an example use case where a first car's headlights 702, 704 are substantially concealed from a driver 706 in a second oncoming car 708 to reduce glare and the associated distraction and reduced vision of surrounding objects. The first car 710 has a pair of projector-style headlights 702, 704, which may adopt any conventional lighting technology (e.g., sealed beam, halogen, xenon, LED, and so on) to illuminate the path ahead. The headlights 702, 704 are each equipped with a first polarized optical filter 712, which may take the form of a film applied to glass or a lens placed over the headlights 702, 704. The optical filter 712 permits a majority of light emitted from the headlights 702, 704 to pass therethrough, specifically light waves of a specific polarization corresponding to the optical filter 712, as illustrated by arrows 714, 716, respectively.

Light emitted from the headlights 702, 704 passes through a windshield of the second oncoming car 708 to reach the driver's eyes. The windshield is equipped with a second using polarized optical filter 718, which is another polarized optical filter taking the form of a film applied to the windshield or a lens that a user wears as eyewear, for example. The optical filter 718 permits a majority of diffuse (e.g., reflected and/or refracted light) between the cars 708, 710 to pass therethrough. However, a majority of light waves are prevented from passing directly from the headlights 702, 704 to the driver's eyes by way of the polarization of the optical filters 712, 718 being oriented approximately 90-degrees from one another. This effect is illustrated by black dot 720 in windshield 722 blocking light from the headlight 704, while a surrounding area of the windshield 722 remains substantially unblocked.

In some implementations, the windshield 722 may adopt areas of differing polarization to more selectively block light. For example, windshield 722 includes a majority of its area with a polarization of the optical filter 718 at approximately 90-degrees from optical filter 712. However, one area 724 of the windshield 722 has a polarization approximately parallel to the optical filter 712. This area 724 corresponds to a discrete area where light from the headlight 702 is to be permitted through the windshield 722 (perhaps for safety reasons so that the first car 710 is visible to the oncoming driver 706. This effect is illustrated by square 726 (illustrated in white) that roughly corresponds to the area 724 in windshield 722 with a different polarization, while a surrounding area 728 of the windshield 722 blocks light from the headlight 702 (illustrated in black) and the further surrounding area 730 of the windshield 722 remains substantially unblocked (illustrated in white). Light output from the headlight 704 may be treated similarly by the windshield 722.

In other implementations, the optical filter 712 may incorporate areas of differing polarization over the headlights 702, 704 to more selectively block light in lieu of the optical filter 718 over the windshield 722 to achieve a similar effect. Further still, both of the optical filters 712, 718 may incorporate areas of differing polarization to achieve similar or different selective blocking of light across an area.

In various implementations herein, and as discussed above, one of the polarized optical filters may be applied on or near a light source and may include films applied to point source lights, such as job site lights and headlamps for automobiles. Another of the polarized optical filters may be applied on or near a user's eyes (e.g., glasses, contact lenses, face masks (e.g., welding masks). Either of the polarized optical filters may be applied to one or more windowpanes oriented between a light source and a user. Various implementations herein may also be used for interferometers, spectral diffusers, 3D scanner, and 3D printers.

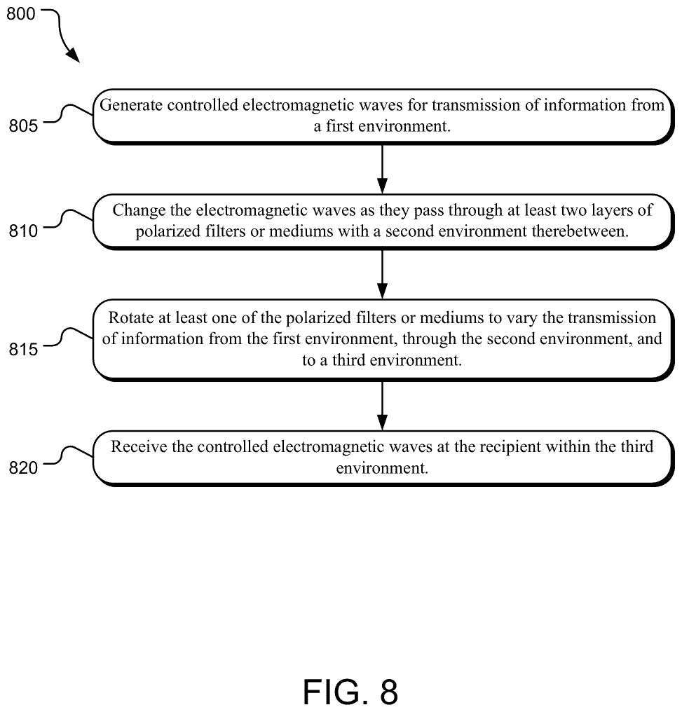

FIG. 8 illustrates example operations 800 for communicating information through at least two polarized filters or media. The operations 800 control wave transmission between various electromagnetic wave sources (including, but not limited to visible light sources) and various electromagnetic recipients (e.g., individuals or sensors), through the use of polarized filters or mediums. A generating operation 805 generates controlled electromagnetic waves for transmission of information from a first environment. The first environment may be any space within which a source of the electromagnetic waves exists and generates the outbound electromagnetic waves. The information may be used in a workspace, such as an office or worksite. The information may be outbound to a recipient as a purposefully targeted recipient or an unintentionally targeted recipient. The recipient being a person or animal, or an electrically, radioactively, or biologically sensitive material.

A manipulating operation 810 changes the electromagnetic waves as they pass through at least two layers of polarized filters or mediums. Each of the polarized media have a different polarization direction, which allows the polarized media when used together to permit some information carried by the electromagnetic waves to pass mostly unimpeded therethrough, while excluding other information or noise from passing though the polarized media. A second environment exists between the two polarized media. In cases with further layers of polarized media, additional environments exist between each of the layers of polarized media between an environment where the source resides and another environment where the recipient resides.

A rotating operation 815 rotates at least one of the polarized filters or mediums. More specifically, the polarized filters or mediums can be rotated about the normal of the direction of electromagnetic wave propagation to affect transmissibility. The electromagnetic wave's electric field is polarized to a vector sum using a first polarizer and a second polarizer is used to reshape the electric field's vector sum to a new vector sum. The number of polarizers and their respective rotated orientations can attenuate electromagnetic waves passing therethrough or create a larger vector sum to be used in a specific stage of shaping the electromagnetic waves passing therethrough. As a result, the rotating operation 815 can be used to selectively affects the information that is passed from the first environment to a third environment.

In an example implementation with three layers of polarized media, the outer two polarized media are set with their polarization 90-degrees apart. The middle polarized media is rotated to create sensitize and non-sensitive zones. If two adjacent polarized media are set with their polarization 90-degrees apart and the remaining outer polarized media is rotated, this affects transmissibility of light from the first environment to the third environment to a greater degree when compared to implementations that only utilize two polarized media layers.

A receiving operation 820 receives the controlled electromagnetic waves at the recipient within the third environment. The electromagnetic waves originating from the first environment are substantially blocked from passing directly through the second environment to the third environment. The third environment may be any space within which the recipient of the electromagnetic waves exists to receive information from the source. In some implementations, the recipient receives attenuated or shaped electromagnetic waves and processes the waves for use by the recipient or to further transmission of the processed electromagnetic waves to another specified target. In other implementations, the electromagnetic waves reflect from and/or absorbs into an object and the resulting electromagnetic waves become diffusive. This diffusive signal may or may not include a polarized signal that travel to the recipient and back to the electromagnetic wave source. The recipient can use the diffusive electromagnetic waves for better signal processing without the electromagnetic wave source information disrupting the recipient's ability to process the diffusive signal.

The electromagnetic waves created in the generating operation 805 may transmit information from a single-point or multi-point source, such as a display screen. Further, for the receiving operation 820, there may be an array of sensors receiving such a Multiple Input Multiple Output (MIMO) signal. Still further, the medium through which the electromagnetic waves travel can be anything including water, air, and a near vacuum (e.g., space).

In some implementations, the electromagnetic reach a polarizer in position to reshape the electromagnetic waves to affect a particular point of the medium with an increased electric field vector sum. This effects a response where a lower electric field vector sum has a lower effect. Further, the electromagnetic waves could be used within a space created by physical separation of polarizers and the sensor can also be in any space created by the separation of polarized filters or mediums, wherein the diffusive information is shaped or attenuated to create privacy from one polarizer space to another. This could have physiological effects as well as information control.

The presently disclosed polarizers can be of any number of types including but not limited to linear and circular polarizers. The polarizers may be applied as a film on a transparent glass or plastic structure, of the polarizers may be their own separate structure. Further, the individual polarizers may be uniform or non-uniform within an implementation and each polarizer may have regions of specific changes as to block out, focus or reshape electromagnetic waves passing therethrough.

The presently disclosed polarizers may be used to sort materials, such as during manufacturing, by recognizing material states through process and identification. Specifically, using electromagnetic waves, sensors, and multiple polarizers on in-process components may make the in-process components more easily identifiable using the items' shape, material and color. Further, directed energy from electromagnetic waves may be used to create a reactive state within a product so as to distinguish or homogenize states which create discernable differences in the product. Still further, features such as color, texture, reflectivity can used by an in-process component identification technique using single or multiple electromagnetic waves with single or multiple sensor positions and multiple polarizers.

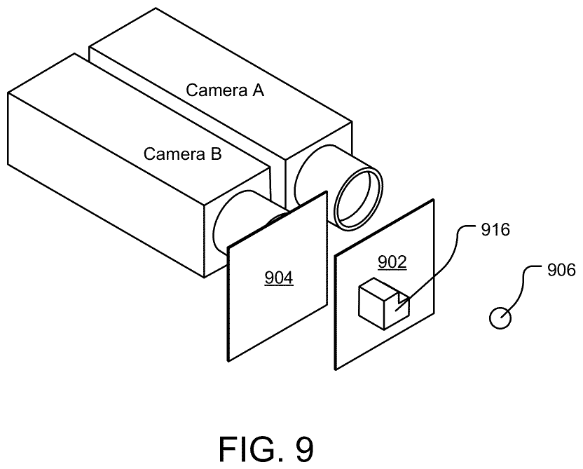

For example, FIG. 9 illustrates a point source of light 906 that illuminates an object of interest 916. Camera A has a point of view of the object of interest 916 through polarizer 902 only. While the polarizer 902 may block some light emitted from the point source of light 906, it also may block some light illuminating the object of interest 916. Thus, the view of the object of interest 916 from Camera A is partially washed out by noise from the point source of light 906 or other light sources on a side of the polarizer 902 opposite Camera A. Camera B has a point of view of the object of interest 916 through both polarizers 902, 904. The polarizers 902, 904 are oriented such that light emitted directly from the point source of light 906 is substantially obscured, while light reflected or refracted from the object of interest 916 substantially pass through the polarizers 902, 904. In this manner, Camera B is better positioned to view the object of interest 916 with less noise from the point source of light 906 or other sources of light. This allows Camera B to better view features of the object of interest 916, including by not limited to color, texture, reflectivity, which can used by an in-process component identification technique as discussed above.

Further still, multiple polarizers may be used with corresponding electromagnetic wave sources and sensors to create sensitive and non-sensitive and sensitive spaces using the separation of the polarizers. The sensitive and non-sensitive can give different type of object recognition information from the in-process components so as to process more information states.

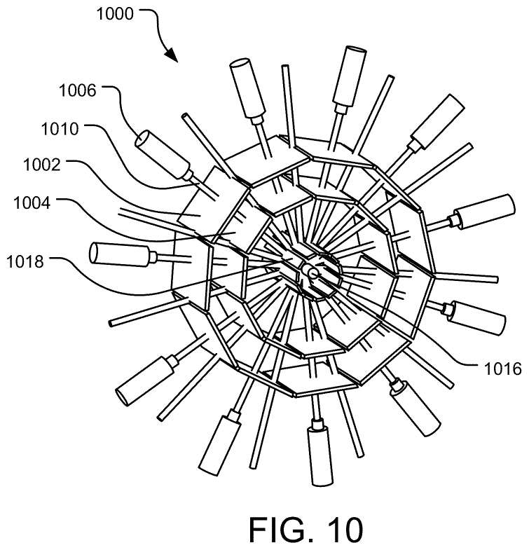

For example, FIG. 10 illustrates a radial arrangement of polarizers with corresponding electromagnetic wave sources focused on sensors on an object 1016 or within an area of interest. For example, electromagnetic wave source 1006 directs a beam of light 1010 (e.g., a laser) through a pair of polarizers 1002, 1004 at the object 1016, which has an arrangement of mirrors (e.g., mirror 1018) arranged thereon. The beam of light 1010 is reflected back from the object 1016 via mirror 1018 and may be collected by one or more sensors (not shown). In other implementations, instead of an arrangement of mirrors placed on the object 1016, the sensors are placed on the object 1016 in a similar arrangement and no reflection of light is necessary to image the object 1016.

The radial arrangement 1000 depicted in FIG. 10 allows imaging of the object 1016 or area of interest in 360 degrees simultaneously and without having to rotate the object 1016 or a singular electromagnetic wave source 1006 and its corresponding polarizers 1002, 1004. Similarly, the object 1016 could be surrounded by a spherical arrangement of electromagnetic wave sources and corresponding polarizers to image the object 1016 or area of interest in three-dimensions simultaneously. The various applications of a linear system of electromagnetic wave source(s), polarizer(s), and object(s) of interest discussed elsewhere herein could be applied to a radial or three-dimensional system such as that illustrated in FIG. 10. Particular example applications could be three-dimensional object printing, targeted material ablation (e.g., Gamma Knife radiosurgery), tissue disintegration, tissue imaging, or any other application where measuring or defining specific metes and bounds of an object or area of interest in two or three dimensions is important. A measurement of an object or area of interest which be used convert to that object or area of interest into a different form via a process of measuring the object or area of interest and converting the medium to another form (e.g., a sensitive liquid can be selectively hardened).

In some implementations, the electromagnetic waves and sensors are able to use frequency separation/signal processing techniques in conjunction with the polarization techniques discussed above. This allows for further processing to pass, block, form, or otherwise manipulate the electromagnetic waves for further needs down the line (e.g., separation of light frequencies for color separation). Polarizer types could operate on a selections of frequencies (e.g., 1 color, selective notches, band-pass, etc.).

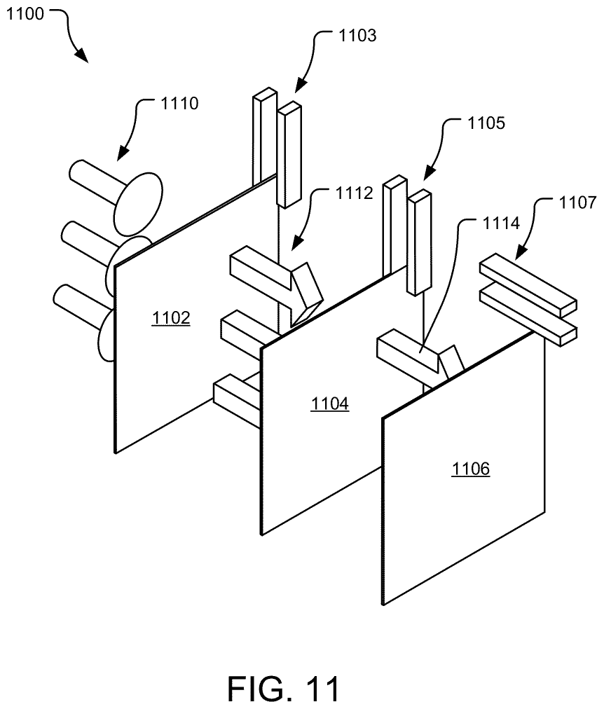

For example, FIG. 11 illustrates a system 1100 of a set of three polarizers 1102, 1104, 1106 that operate in combination to separate constituent frequencies of an incoming beam of light (illustrated by blunt arrows 1110) from a source (not shown), polarize that light (illustrated by pointed arrows 1112) so as to distinguish that light from other light incoming from other sources, and filter those frequencies to pass only those of interest (illustrated by one arrow 1114 of arrows 1112 passing through polarizer 1106) that are specific to the source. The polarizers 1102, 1104, 1106 have example orientations 1103, 1105, 1107, respectively. While the functionality of polarizers 1102, 1104, 1106 is noted above in a specific order, other orders of separation, polarization, and filtration of electromagnetic waves for the purpose of communication information are contemplated herein.

In an example implementation, the system 1100 could be used by a first party to communicate information securely across a large and noisy environment to a second party. Specifically, the first party may generate a beam of light (or other EM waves), separate those waves into numerous polarized waves, one or some of which are encoded with information to be communicated (e.g., using polarizers 1102, 1104). The second party receives the beam of light and possesses a specific third polarizer (here, polarizer 1106) that permits only a specific frequency or frequencies of the beam of light to pass, while filtering out the other constituent frequencies of the beam of light and other light noise within the environment. As the specific frequency or frequencies of the beam of light contain the encoded information, the second party receives that information, while its content is obscured from any other party that does not possess the polarizer 1106.

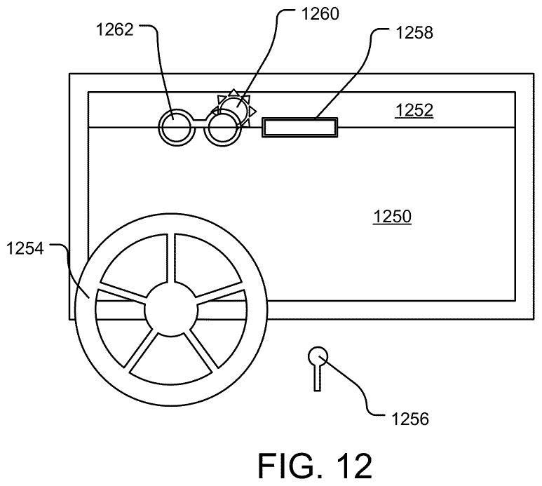

FIG. 12 illustrates a driver's perspective through a windshield 1250 equipped with a polarized shade band 1252. The driver (not shown) sits behind steering wheel 1254 and adjacent gear shift 1256. The polarized shade band 1252 is typically placed at the top of the windshield 1250 and behind rear view mirror 1258, as illustrated in FIG. 12, although other placements of the polarized shade band 1252 are contemplated herein.

A typical shade band is placed as depicted in FIG. 12, but is merely a shaded and perhaps colorized portion of the windshield 1250 to help with glare from sun 1260. The polarized shade band 1252 may provide a similar shaded view when utilized without polarized glasses 1262. However, when the driver puts the polarized glasses 1262, this substantially blocks all light from view. This allows the driver to selectively change their perspective of opaqueness of the polarized shade band 1252 based on wearing or not wearing the polarized glasses 1262. Still further, if the polarization direction of the polarized glasses 1262 is adjustable by the driver, the driver can change the opaqueness of the polarized shade band 1252 by adjusting the polarized glasses 1262.

In another implementation, the polarized shade band 1252 could be applied to some or all of a building window and can be used specifically to block out the sun from a user inhabiting the building. The modularity allows the user to adjust or remove one or many polarized filters (e.g., the polarized glasses 1262) to fit their needs as the environment changes (or the needs of the user changes). In various implementations, this can help address vertigo, headaches or migraines, acrophobia, etc. For example, a user's acrophobia could be addressed by blocking out the building window but still allowing the user to see inside apartment. In further implementations, the window may have photovoltaically actuated polarization material that can be digitally activated, thereby adding additional control over the perceived opacity of the window to the user.

The presently disclosed technology may be implemented as logical steps in one or more computer systems (e.g., as a sequence of processor-implemented steps executing in one or more computer systems and as interconnected machine or circuit modules within one or more computer systems). The implementation is a matter of choice, dependent on the performance requirements of the computer system implementing the presently disclosed technology. Accordingly, the logical operations making up implementations of the presently disclosed technology are referred to variously as operations, method steps, objects, or modules. Furthermore, it should be understood that logical operations may be performed in any order, adding or replacing operations as desired, unless explicitly claimed otherwise or a specific order is inherently necessitated by the claim language. Still further, the various implementations of the presently disclosed technology herein may be combined, in whole or in part.

The above specification, examples, and data provide a complete description of the structure and use of exemplary implementations of the presently disclosed technology. Since many implementations of the presently disclosed technology can be made without departing from the spirit and scope of the invention, the presently disclosed technology resides in the claims hereinafter appended. Furthermore, structural features of the different implementations may be combined in yet another implementation without departing from the recited claims.

What is claimed is:

1. An electromagnetic communication system comprising:
an electromagnetic source existing in a first environment;
a first polarized medium having a first polarization direction separating the first environment from a second environment; and
a second polarized medium having a second polarization direction separating the second environment from a third environment, the first polarization direction differing from the second polarization direction, wherein electromagnetic waves originating from the first environment are substantially blocked from passing directly through the second environment to the third environment.

2. The electromagnetic communication system of claim 1, wherein one of the first and the second polarized media is rotatable with reference to the other of the first and the second polarized media, wherein the rotation affects information passed from the first environment to the third environment.

3. The electromagnetic communication system of claim 1, further comprising:
a third polarized medium having a third polarization direction separating the second environment from a fourth environment existing between the second and the third polarized media, wherein the electromagnetic waves originating from the first environment are substantially blocked from passing directly through the second and the fourth environments to the third environment.

4. The electromagnetic communication system of claim 1, wherein the first and the second polarized media are each linear or circular polarizers.

5. The electromagnetic communication system of claim 1, wherein one or both of the first and the second polarized media include an area of non-polarization surrounded by another area of polarization.

6. The electromagnetic communication system of claim 1, wherein one or both of the first and the second polarized filters include a non-uniform pattern of polarization.

7. The electromagnetic communication system of claim 1, further comprising:
multiple sets of additional electromagnetic sources and corresponding polarized media, each set arranged in a radial pattern around an object of interest and focused on the object of interest.

8. The electromagnetic communication system of claim 1, further comprising:
multiple sets of additional electromagnetic sources and corresponding polarized media, each set arranged in three-dimensions around an on object of interest and focused on the object of interest.

9. A method for communicating information through at least two polarized filters comprising:
generating electromagnetic waves for transmission of information from a first environment;
changing the electromagnetic waves as they pass through two polarized media, each having a different polarization direction, a second environment existing between the two polarized media;
receiving the electromagnetic waves at a recipient in a third environment, wherein the electromagnetic waves originating from the first environment are substantially blocked from passing directly through the second environment to the third environment.

10. The method of claim 9, further comprising:
rotating one of the polarized media with reference to the other of the polarized media, wherein the rotation affects the information passed from the first environment to the third environment.

11. A light communication system comprising:
a light source existing in a first environment;
a first polarized filter having a first polarization direction separating the first environment from a second environment; and
a second polarized filter having a second polarization direction separating the second environment from a third environment, the first polarization direction differing from the second polarization direction, wherein light originating from the first environment is substantially blocked from passing directly through the second environment to the third environment.

12. The light communication system of claim 11, wherein one of the first and the second polarized filters is rotatable with reference to the other of the first and the second polarized filters, wherein the rotation affects information passed from the first environment to the third environment.

13. The light communication system of claim 11, further comprising:
a third polarized filter having a third polarization direction separating the second environment from a fourth environment existing between the second and the third polarized filters, wherein the light originating from the first environment is substantially blocked from passing directly through the second and the fourth environments to the third environment.

14. The light communication system of claim 13, wherein the first, second, and third polarized filters function to separate constituent frequencies of light coming from the light source, polarize the light coming from the light source, and filter the light coming from the light source to pass only one or more frequencies of interest that are specific to the light source.

15. The light communication system of claim 11, wherein the first and the second polarized filters are each linear or circular polarizers.

16. The light communication system of claim 11, wherein one or both of the first and the second polarized filters include an area of non-polarization surrounded by another area of polarization.

17. The light communication system of claim 11, wherein one or both of the first and the second polarized filters include a non-uniform pattern of polarization.

18. The light communication system of claim 11, wherein the light source illuminates a target in the second environment, and the target is visible from the third environment, but light emitted from the light source is substantially blocked from the third environment.

19. The light communication system of claim 11, further comprising:
multiple sets of additional light sources and corresponding polarized filters, each set arranged in a radial pattern around an object of interest and focused on the object of interest.

20. The light communication system of claim 11, further comprising:
multiple sets of additional light sources and corresponding polarized filters, each set arranged in three-dimensions around an on object of interest and focused on the object of interest.
